(19) United States
(12) Patent Application Publication
(10) Pub. No.: US 2026/0175472 A1
(43) Pub. Date: Jun. 25, 2026

(54) METHOD AND APPARATUS FOR SEPARATING FOREIGN MATTER FROM PULVERIZED RUBBER

(71) Applicant: TOYODA GOSEI CO., LTD., Kiyosu-shi (JP)

(72) Inventors: Naoto KURIYAMA, Aichi (JP); Kenji KOBAYASHI, Aichi (JP); Kiyokazu SODEYAMA, Aichi (JP); Koji SENDA, Aichi (JP); Yasuhiro YAMAGUCHI, Aichi (JP)

(21) Appl. No.: 19/426,466

(22) Filed: Dec. 19, 2025

(30) Foreign Application Priority Data
Dec. 25, 2024 (JP) 2024-228293

(51) Int. Cl. B29B 17/02; B03B 1/04; B03B 5/28; B03B 9/06

(52) U.S. Cl. CPC B29B 17/02; B03B 1/04; B03B 5/28; B03B 9/06; B29B 2017/0244

(57) ABSTRACT

A method for separating, from a pulverized rubber having a specific gravity of more than 1, a foreign matter mixed in the pulverized rubber, includes: separating a high specific gravity foreign matter having a specific gravity of more than 1, which is submerged in water, by floating the pulverized rubber on the water by a surface tension of the water acting upward; and separating a low specific gravity foreign matter having a specific gravity of less than 1, which floats on the water, by submerging the pulverized rubber in the water by a process of eliminating or reducing the surface tension of the water acting upward.

### CROSS-REFERENCE TO RELATED APPLICATION

This application is based on and claims priority under 35 USC 119 from Japanese Patent Application No. 2024-228293 filed on Dec. 25, 2024.

### TECHNICAL FIELD

The present invention relates to separation of a foreign matter from a pulverized rubber.

### BACKGROUND ART

Recycling of used rubber products such as tires, seal parts, buffer parts, and hoses is becoming more important. Various foreign matters such as a metal, a stone, sand, mud, wood, and a plastic adhere to the used rubber products. Although these foreign matters are less likely to be a problem in the case of combustion and thermal decomposition such as thermal recycling, they need to be separated from the rubber products since recycling without this will damage recycling facilities and reduce the quality of the regenerated rubber. Therefore, various methods for pulverizing a rubber product and separating foreign matters from the pulverized rubber have been studied.

Patent Literature 1 describes a method in which a disposable rubber product such as an old tire is pulverized into rubber particles, the rubber particles are charged into a perforated basket of a cleaner together with water, an alkali, and a surfactant, the basket is moved to stir the rubber particles, and during the stirring, contaminants are removed from the rubber particles to perform cleaning. The water, the alkali, the surfactant, and the contaminants are discharged from the holes of the basket, and only the cleaned rubber particles remain in the basket. However, there is a problem that a special basket, alkali, surfactant, and the like are essential.

Patent Literature 2 describes a method for generating and recovering a pulverized vinyl chloride/rubber product and an iron powder by pulverizing molding scraps for automobiles using a Schlenter, pulverizing the pulverized product using a pulverizer, sorting the pulverized product using a vibration sieve, sorting the pulverized product using a wind power sorter, and further performing specific gravity separation using a specific gravity separator. As the specific gravity separator, (1) a water flow sorter which includes an inclined separation plate, a water supply gutter, and a dust collection unit, and which performs specific gravity separation by flowing down and water flow, and (2) a floatation sorter which includes a water tank, a roller, and a screw, which accommodates a pulverized vinyl chloride/rubber product material floating on a water surface in the water tank, and which takes out an iron powder material deposited on a bottom surface of the water tank are shown. However, there is a problem that it is difficult to separate wood wastes or the like having a specific gravity of less than 1 floating on the water surface together with the pulverized vinyl chloride/rubber product material.

Patent Literature 3 describes a method for producing a high purity rubber material, the method including a pulverization step of pulverizing a rubber material containing impurities to finely pulverize the rubber material, and a removal step of removing the impurities adhering to the finely pulverized rubber material. In the pulverization step, the rubber material is pulverized by sliding contact between a cylindrical screen and an inner blade capable of high speed rotation. In the removal step, before the finely pulverized rubber material adheres, the finely pulverized rubber material is washed with water using a pool including a jet water flow device or a water flow pump 16, or a washing machine with a dewatering function. However, there is a problem that a large-scale water flow facility is required.

Patent Literature 4 describes a method for producing a high purity natural rubber, the method including a pulverization step of pulverizing a natural rubber containing a foreign matter to obtain a pulverized rubber, and a removal step of removing the foreign matter adhering to the obtained pulverized rubber. In the pulverization step, the natural rubber is finely pulverized to 3 mm square or less. The method of the removal step is not particularly limited, and it is disclosed that impurities in the rubber can be easily and highly efficiently removed by installing a pool in which water circulates immediately below a pulverizer and washing the finely pulverized rubber with running water. However, there is a problem that a facility for producing a strong water flow is required.
Patent Literature 1: JPH08-509782A
Patent Literature 2: JPH11-207312A
Patent Literature 3: JP2013-141825A
Patent Literature 4: JP2015-42712A

### SUMMARY OF INVENTION

Therefore, an object of the present invention is to make it possible to separate various foreign matters such as a metal, a stone, sand, mud, wood, and a plastic from a pulverized rubber by using a simple facility.

The specific gravity of the rubber varies depending on the kind, and there are rubbers having a specific gravity of less than 1 such as a natural rubber (NR), an isoprene rubber (IR), a styrene-butadiene rubber (SBR), a butadiene rubber (BR), a butyl rubber (IIR), and an ethylene-propylene rubber (EPM, EPDM), and rubbers having a specific gravity of more than 1 such as a chloroprene rubber (CR), a nitrile rubber (NBR), an acrylic rubber (ACM), a urethane rubber (U), and a fluororubber (FKM).

However, since rubber products contain a large amount of inorganic fillers such as carbon black and silica to improve performance, most of the rubber products have a specific gravity of more than 1 regardless of the kind of the rubber. Therefore, most of pulverized rubbers obtained by pulverizing the rubber products also have a specific gravity of more than 1.0, and thus should basically be submerged in water. However, since it has been found from experiments and the like to be described later that the pulverized rubber is wiped or submerged in water, the following means has been reached through further studies.

[1] A method for separating a foreign matter from a pulverized rubber, which is a method for separating, from a pulverized rubber having a specific gravity of more than 1, a foreign matter mixed in the pulverized rubber, the method including:
a high specific gravity foreign matter separation step of separating a high specific gravity foreign matter having a specific gravity of more than 1, which is submerged in water, by floating the pulverized rubber on the water by a surface tension of the water acting upward; and
a low specific gravity foreign matter separation step of separating a low specific gravity foreign matter having a specific gravity of less than 1, which floats on the water, by submerging the pulverized rubber in the water by eliminating or reducing the surface tension of the water acting upward.

### (Effects)

As shown in FIG. 6A and FIG. 7A, when the pulverized rubber is scattered in water, most of the pulverized rubber floats on water. It is presumed to be because a surface of the pulverized rubber is hydrophobic due to exudation of an oil contained in the rubber and has poor wettability to water, so that a contact angle θ>90°, and a surface tension y of water acts upward and is higher than a self weight w of the pulverized rubber. When the pulverized rubber floats on water in this manner, the low specific gravity foreign matter having a specific gravity of less than 1 mixed in the pulverized rubber floats on water together with the pulverized rubber, but the high specific gravity foreign matter having a specific gravity of more than 1 mixed in the pulverized rubber is submerged in water and is separated from the pulverized rubber, and thus can be removed (high specific gravity foreign matter separation step).

When the upward surface tension is eliminated or reduced as shown in FIGS. 6B and 7B, the pulverized rubber is submerged in water as shown in FIGS. 6C and 7C. When the pulverized rubber is submerged in water in this manner, the low specific gravity foreign matter having a specific gravity of less than 1 remains floating on water and is separated from the pulverized rubber, and thus can be removed (low specific gravity foreign matter separation step).

[2] The method for separating a foreign matter from a pulverized rubber according to [1], in which a method of eliminating or reducing the surface tension of the water acting upward is to cover the pulverized rubber with water.

### (Effects)

When the pulverized rubber is covered with water as shown in FIG. 6B, the pulverized rubber is submerged in the water as shown in FIG. 6C. It is presumed that when the pulverized rubber is covered with water, the oil is not removed from the surface of the pulverized rubber, but the contact angle is reduced by water temporarily hitting the entire side surface of the pulverized rubber, and the upward surface tension is eliminated, so that the pulverized rubber is submerged in the water by the self weight.

As shown in FIG. 6D, the pulverized rubber once submerged in water is taken out from water, and when scattered into water again, it floats on water again. It is presumed to be because the oil is less likely to be removed from the surface of the pulverized rubber even when the pulverized rubber is once submerged in water, so that the surface of the pulverized rubber taken out from water remains hydrophobic, and the surface tension of water acts upward as in FIG. 6A.

[3] The method for separating a foreign matter from a pulverized rubber according to [1], in which a method of eliminating or reducing the surface tension of the water acting upward is to add a surfactant to the water.

### (Effects)

FIG. 7A shows a state where the pulverized rubber floats on water, similar to FIG. 6A.

When a surfactant is added to water as shown in FIG. 7B, the pulverized rubber is submerged in water as shown in FIG. 7C. It is presumed that since the surfactant is adsorbed on the surface of the pulverized rubber and a hydrophilic group is directed outward, the surface of the pulverized rubber is hydrophilic, the wettability is improved, the contact angle is 0<90°, the upward surface tension is eliminated, the surface tension y acts downward, and the pulverized rubber is submerged in water.

An amount of the surfactant added to water is preferably 0.1 mass % to 1.0 mass %, and more preferably 0.2 mass % to 0.4 mass %.

As shown in FIG. 7D, the pulverized rubber once submerged in water is taken out from water, and when scattered into water again, it is submerged in water. This is because the surfactant remains on the surface of the pulverized rubber even when the pulverized rubber is taken out from water, and thus the surface of the pulverized rubber remains hydrophilic, and the surface tension of water acts downward as in FIG. 7B. Therefore, at this time, it is difficult to remove the high specific gravity foreign matter submerged in water.

[4] The method for separating a foreign matter from a pulverized rubber according to [1], in which a method of eliminating or reducing the surface tension of the water acting upward is to add an alcohol to the water.

### (Effects)

When an alcohol is added to water, since a surface tension of the alcohol is lower than the surface tension of water, the surface tension is lower than that in the state in FIG. 6A, the contact angle is smaller, the surface tension y acting upward is not higher than the self weight w of the pulverized rubber, and the pulverized rubber is submerged in water. As a specific example, a container, a sample 2, and water same as those in Experiment 1 to be described later are used, and when 50 g of water is charged into the container, 1 g of the sample 2 is gently charged into the container from above to float on water, and then 4 mass % of ethanol is charged into water, 96% of the floating pulverized rubber (proportion of the number of pulverized rubber particles, the same applies hereinafter) is submerged.

The alcohol is not particularly limited, and examples thereof include methyl alcohol, ethyl alcohol, and isopropyl alcohol.

An amount of the alcohol added to water is preferably 1.0 mass % to 10.0 mass %, and more preferably 3.0 mass % to 4.0 mass %.

[5] The method for separating a foreign matter from a pulverized rubber according to [1], in which a method of eliminating or reducing the surface tension of the water acting upward is to increase a temperature of the water.

### (Effects)

When the temperature of the water is increased, the surface tension is lower than that in the state in FIG. 6A, the contact angle is smaller, the surface tension y acting upward is not higher than the self weight w of the pulverized rubber, and the pulverized rubber is submerged in water. As a specific example, the container, the pulverized rubber (sample 2), and the water same as those in Experiment 1 to be described later are used, and when 50 g of water (about 35° C.) is charged into the container, 1 g of the pulverized rubber is gently charged into the container from above to float on water, and then the temperature of water is increased to 65° C., 65% of the floated pulverized rubber is submerged.

The temperature of water is preferably 40° C. or lower before being increased (high specific gravity foreign matter separation step), and is preferably increased to 60° C. or higher (more preferably 70° C. or higher).

[6] The method for separating a foreign matter from a pulverized rubber according to [1], in which a method of eliminating or reducing the surface tension of the water acting upward is to apply ultrasonic vibration to the water.

### (Effects)

When ultrasonic vibration is applied to water, the surface tension is lower than that in the state in FIG. 6A, the contact angle is smaller, the surface tension y acting upward is not higher than the self weight w of the pulverized rubber, and the pulverized rubber is submerged in water. As a specific example, the container, the pulverized rubber (sample 2), and the water same as those in Experiment 1 to be described later are used, and when 50 g of water is charged into the container, 1 g of the pulverized rubber is gently charged into the container from above to float on water, and then the container is put into an ultrasonic cleaner (BRANSONIC M2800-J manufactured by EMERSON) to be subjected to ultrasonic vibration, 38% of the floating pulverized rubber (proportion of the number of pulverized rubber particles, the same applies hereinafter) is submerged.

[7] The method for separating a foreign matter from a pulverized rubber according to claim any one of [1] to [6], in which the high specific gravity foreign matter separation step is performed, and then the low specific gravity foreign matter separation step is performed.

### (Effects)

In the high specific gravity foreign matter separation step, the pulverized rubber is floated on water to separate the high specific gravity foreign matter submerged in water, and then in the low specific gravity foreign matter separation step, the pulverized rubber is submerged in water to separate the low specific gravity foreign matter floating on water. Therefore, a step of floating again the pulverized rubber once submerged in water on water is not required, which is efficient.

[8] An apparatus for separating a foreign matter from a pulverized rubber, including:
a first water tank configured to float the pulverized rubber on water by a surface tension of the water acting upward to separate a high specific gravity foreign matter having a specific gravity of more than 1, which is submerged in the water; and
a second water tank configured to submerge the pulverized rubber in water by eliminating or reducing the surface tension of the water acting upward to separate a low specific gravity foreign matter having a specific gravity of less than 1, which floats on the water, in which
the pulverized rubber floating on the water in the first water tank is sent to the second water tank together with overflowing water.

### (Effects)

Since the separation of the high specific gravity foreign matter in the first water tank and the separation of the low specific gravity foreign matter in the second water tank are performed simultaneously and continuously, efficiency is high.

[9] The apparatus for separating a foreign matter from a pulverized rubber according to [8], in which the first water tank is provided with a hopper configured to supply the pulverized rubber onto the water, and a first removing device configured to remove the high specific gravity foreign matter submerged in the water.

[10] The apparatus for separating a foreign matter from a pulverized rubber according to [8] or [9], in which the second water tank is provided with a water stirring device configured to generate waves in a water surface portion, to cover the pulverized rubber floating on the water with the waves, so as to submerge the pulverized rubber in the water, and a second removing device configured to remove the low specific gravity foreign matter floating on the water.

[11] The apparatus for separating a foreign matter from a pulverized rubber according to any one of [8] to [10], in which a surfactant is added to the water in the second water tank.

[12] The apparatus for separating a foreign matter from a pulverized rubber according to any one of [8] to [11], further including: a recovery device configured to recover the pulverized rubber taken out from the second water tank.

As can be seen from the above, the present invention can be performed with a simple facility since a facility for producing a strong water flow is not essential. However, the present invention does not exclude a water flow, and for example, a weak water flow may be applied to water.

According to the present invention, it is possible to separate various foreign matters such as a metal, a stone, sand, mud, wood, and a plastic from a pulverized rubber by using a simple facility.

### BRIEF DESCRIPTION OF DRAWINGS

FIG. 1 show photographs showing Experiment 1 for embodiments.

FIG. 2 show photographs similarly showing Experiment 2.

FIG. 3 show photographs similarly showing Experiment 3.

FIG. 4 show photographs similarly showing Experiment 4.

FIG. 5 show photographs similarly showing Experiment 5.

FIGS. 6A, 6B, 6C, and 6D are diagrams illustrating a mechanism of action in Experiment 1.

FIGS. 7A, 7B, 7C, and 7D are diagrams illustrating a mechanism of action in Experiment 2.

FIG. 8 is a schematic diagram of an apparatus used in a first embodiment.

FIG. 9A is a partial schematic diagram of an apparatus used in a second embodiment, and FIG. 9B is a partial schematic diagram of an apparatus used in a third embodiment.

FIG. 10 is a schematic diagram of an apparatus used in a fourth embodiment.

### DESCRIPTION OF EMBODIMENTS

### <1> Pulverized Rubber

A pulverized rubber is obtained by pulverizing a rubber, and is not limited in a pulverization method.

The pulverized rubber is not particularly limited, and a pulverized rubber obtained by pulverizing a used rubber product (tires, seal parts, buffer parts, hoses, or the like) is preferred from the viewpoint of recycling.

The rubber kinds of the pulverized rubber is not particularly limited, and examples thereof include NR, IR, SBR, BR, IIR, EPM, EPDM, CR, NBR, ACM, U, and FKM.

The shape of the pulverized rubber is not particularly limited, and examples thereof include a granular shape, a flake shape, and a linear shape.

The dimensions of the pulverized rubber are not particularly limited, and examples thereof include those in which the longest portion has a length of 1 mm to 10 mm.

### <2> Foreign Matter

A foreign matter mixed in the pulverized rubber is not particularly limited, and examples thereof include a metal, a stone, sand, mud, wood, and a plastic.

Examples of a high specific gravity foreign matter having a specific gravity of more than 1 include a metal, a stone, sand, and a plastic (a polyvinyl chloride, a polystyrene, ABS, a polyacetal, an acrylic material, a polycarbonate, a polyamide, a polyurethane, a fluorine-based material, or the like).

Examples of a low specific gravity foreign matter having a specific gravity of less than 1 include wood and a plastic (a polyethylene, a polypropylene, EVA, or the like).

### <3> Water

Water is not particularly limited, and examples thereof include tap water, well water, rainwater, and distilled water.

Water may contain an additive that does not substantially influence a surface tension thereof.

A temperature of water is not particularly limited, and is preferably 40° C. or lower. This is because the surface tension is large.

### <3> High Specific Gravity Foreign Matter Separation Step

In a high specific gravity foreign matter separation step, a method of floating the pulverized rubber on water by the surface tension of water acting upward is not particularly limited, and it is preferable to supply the pulverized rubber onto water such that water adheres to a bottom surface of the pulverized rubber and even when water adheres to a part of a side surface of the pulverized rubber, it does not adheres to the entire side surface. The supplying method is not particularly limited, and the following methods can be exemplified. (a) The pulverized rubber is scattered to be dispersed on water immediately above water (preferably within 10 cm from a water surface, and more preferably within 5 cm from the water surface). Specific examples thereof include, but are not particularly limited to, a method of supplying the pulverized rubber onto water from a hopper, and moving the hopper in a horizontal direction or moving a water surface portion of water at this time. (b) The pulverized rubber once submerged in water is pulled up above water and exposed to air, and then scattered in the same manner as in (a).

### <4> Low Specific Gravity Foreign Matter Separation Step

In a low specific gravity foreign matter separation step, a method of eliminating or reducing the surface tension acting upward is not particularly limited, and the following methods can be exemplified.
(a) The pulverized rubber is covered with water. Specifically, the following method can be exemplified.
   The pulverized rubber is covered with waves generated on the water surface portion. Examples of a method of generating waves include stirring and oscillation of water. Examples of a stirring method include stirring the water surface portion using a water turbine, and strongly stirring a water bottom portion provided with a rotating body.
   Water is sprayed onto the pulverized rubber. A sprinkling device can be used for this purpose.
   The pulverized rubber is pushed into water. A pushing jig can be used for this purpose.
   The pulverized rubber is vigorously charged into water.
(b) A surfactant is added to water.
(c) An alcohol is added to water.
(d) The temperature of water is increased.
(e) Ultrasonic vibration is applied to water.

### <5> Order of Steps

The order of the high specific gravity foreign matter separation step and the low specific gravity foreign matter separation step is not particularly limited, and the following order can be exemplified.
(a) The high specific gravity foreign matter separation step is performed, and then the low specific gravity foreign matter separation step is performed.
(b) The low specific gravity foreign matter separation step is performed, and then the high specific gravity foreign matter separation step is performed.
(c) The high specific gravity foreign matter separation step is performed, then the low specific gravity foreign matter separation step is performed, and then the high specific gravity foreign matter separation step is performed again.

### <4> Additional Effects

By separating various foreign matters from the pulverized rubber, the following additional effects can be obtained. • A defect such as clogging or chipping of a screw does not occur in a rubber regeneration step, which is the next step. • The quality of a regenerated rubber material is improved, and even when the regenerated rubber material is mixed with a virgin rubber and commercialized, the tensile strength and the elongation do not decrease.

### EMBODIMENTS

Next, embodiments (including Experiments) of the present invention will be described. Note that, materials, conditions, structures, shapes, and dimensions in the embodiments are merely examples, and can be appropriately modified without departing from the spirit of the invention.

### [Experiment 1]

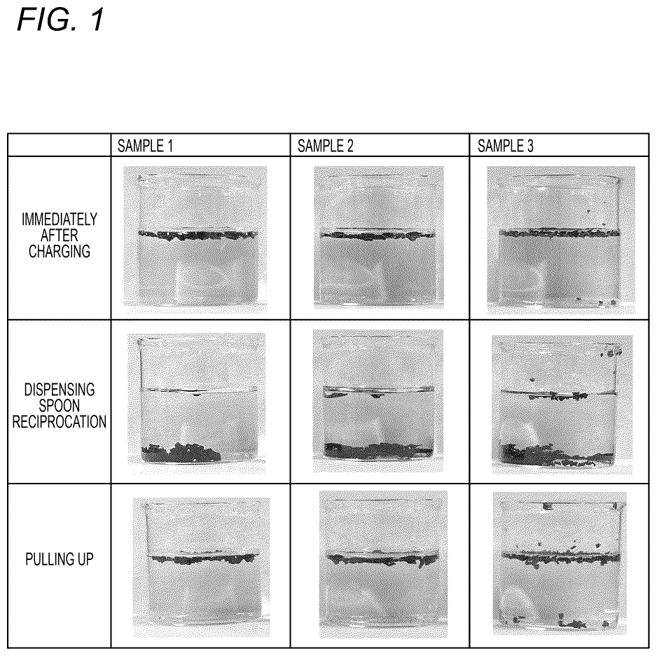

As Experiment 1, as shown in FIG. 1, an experiment of floating and submerging various rubber scraps on and in water was performed.

A sample 1 is a pulverized rubber obtained by pulverizing a new rubber blended by the present applicant, and has a particle diameter of about 6 mm and a specific gravity of 1.04. No foreign matter is mixed.

A sample 2 is a pulverized rubber obtained by pulverizing a tread surface portion of a tire collected from the market, and has a particle diameter of about 6 mm and a specific gravity of 1.07. The foreign matter was removed in advance.

A sample 3 is a pulverized rubber obtained by pulverizing the entire tire collected from the market, and has a particle diameter of 1 mm to 3 mm and a too small specific gravity, which is difficult to measure accurately, but is more than 1. The foreign matter was removed in advance.

As the container, three glass containers each having an opening diameter of 45 mm and a height of 50 mm were used.

As a stirrer, a stainless steel dispensing spoon having a dish portion length of 20 mm and a handle portion length of 140 mm was used.

Tap water was used as water. The water temperature was about 35° C.

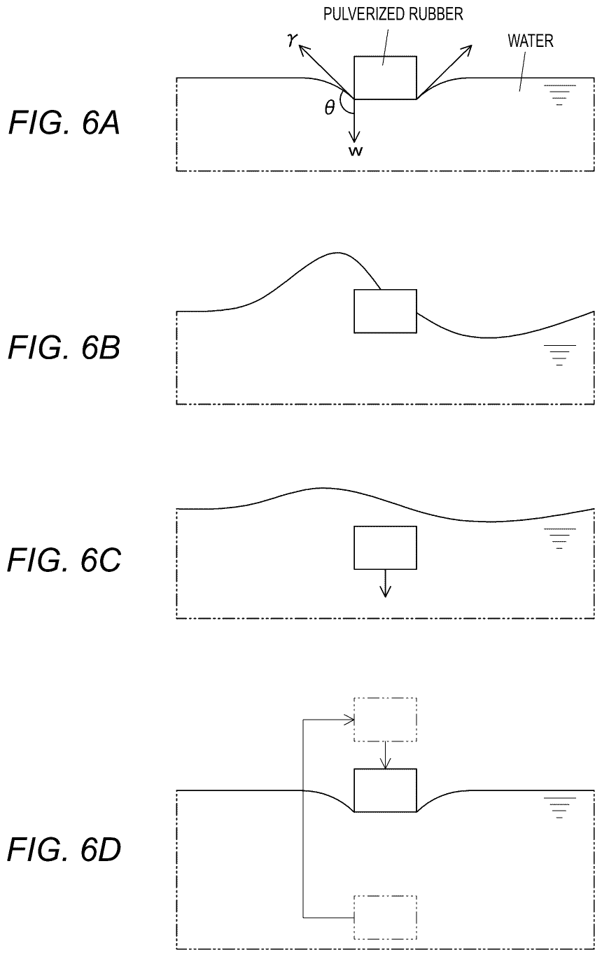

(1) When 50 g of water was charged into each container and 1 g of each sample was gently charged into the container from above, as shown in an upper part in FIG. 1, substantially both of the samples 1 and 2 floated on water, and most of the sample 3 floated on water and about 1% thereof (proportion of the number of pulverized rubber particles, the same applies hereinafter) was submerged in water. As described above with reference to FIG. 6A, it is presumed that the samples 1 to 3 float on water since the surface tension γ of water acts upward. Note that, it is considered that the reason why the sample 3 is submerged in water is that different rubber components are mixed in each portion of the tire, which causes differences in oil contained and in amount of the exuded oil.

(2) Thereafter, when a stirring operation of reciprocating the dispensing spoon in a lateral direction in a state where the dispensing spoon was inserted into water to the middle of the dish portion was performed for 1 minute at 2 reciprocations/second, as shown in a middle part in FIG. 1, waves were generated in the water surface portion, most of the samples 1 to 3 were submerged in water, and about 1% of the sample 1, about 2% of the sample 2, and about 5% of the sample 3 remained floating on water. As described above with reference to FIGS. 6B and 6C, it is presumed that the samples 1, 2, and 3 are submerged in water since the upward surface tension is eliminated when the pulverized rubber is covered with water by waves in the water surface portion. Note that, it is considered that the reason why a relatively large part of the sample 3 remains floating is because different rubber components are mixed in each portion of the tire.

(3) Thereafter, when each of the submerged samples was pulled up to above the water surface with a dispensing spoon and then gently charged into water from above again, as shown in a lower part in FIG. 1, the samples 1 and 2 substantially entirely floated on water, and most of the sample 3 floated on water and about 4% thereof remained submerged in water. As described above with reference to FIG. 6D, it is presumed that the samples 1 and 3 float on water again since the oil is less likely to be removed from the surface of the pulverized rubber, and thus the surface tension of water acts upward. Note that, it is considered that the reason why the sample 3 remains submerged is because different rubber components are mixed in each portion of the tire.

### [Experiment 2]

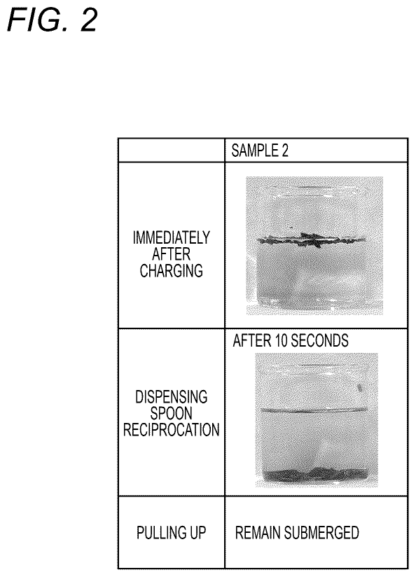

As Experiment 2, as shown in FIG. 2, verification was performed by adding a surfactant to water.

The same sample 2, container, dispensing spoon, and water as in Experiment 1 were used.

As the surfactant, a detergent containing sodium 16% alkyl ether sulfate was used.

(1) When 50 g of water was charged into the container and 1 g of the sample 2 was gently charged into the container from above, as shown in an upper part in FIG. 2, substantially the entire sample 2 floated on water.

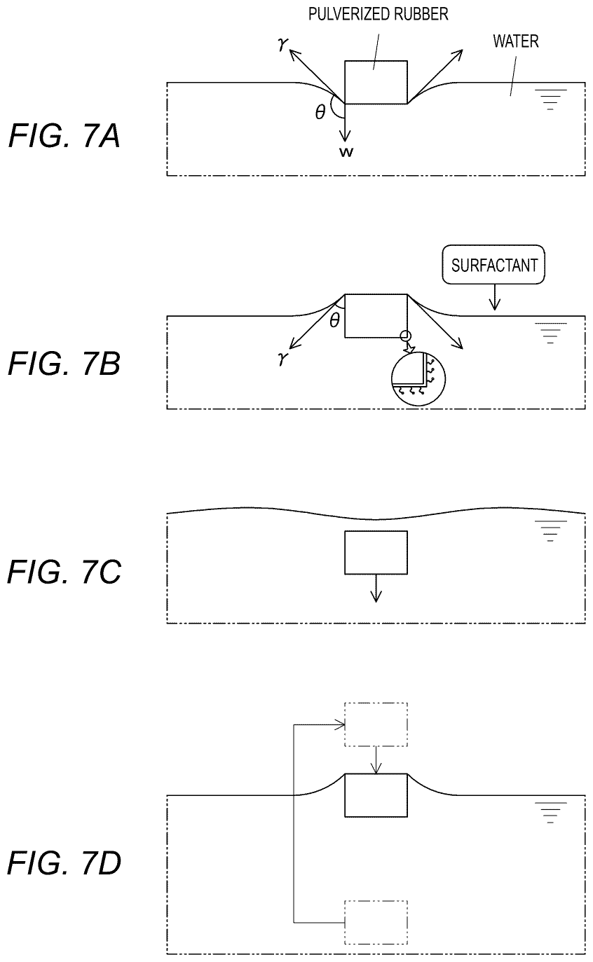

(2) Thereafter, 0.1 g of the surfactant was added to water. Thereafter, when a stirring operation of reciprocating the dispensing spoon in a lateral direction in a state where the dispensing spoon was inserted into water to the middle of the dish portion was performed for 10 seconds at 2 reciprocations/second, as shown in a middle part in FIG. 2, the entire sample 2 was submerged in water. As described above with reference to FIGS. 7B and 7C, it is presumed that the sample 2 is submerged in water since the surface of the pulverized rubber is hydrophilic due to the surfactant and the upward surface tension is eliminated.

(3) Thereafter, when the submerged sample 2 was pulled up to above the water surface with a dispensing spoon and then gently charged into water from above again, as shown in a lower part in FIG. 2, the sample 2 was submerged in water (without floating). As described above with reference to FIG. 7D, the sample 2 is submerged in water since the surfactant remains on the surface of the pulverized rubber even when the pulverized rubber is taken out from water, and thus the surface of the pulverized rubber remains hydrophilic.

### [Experiment 3]

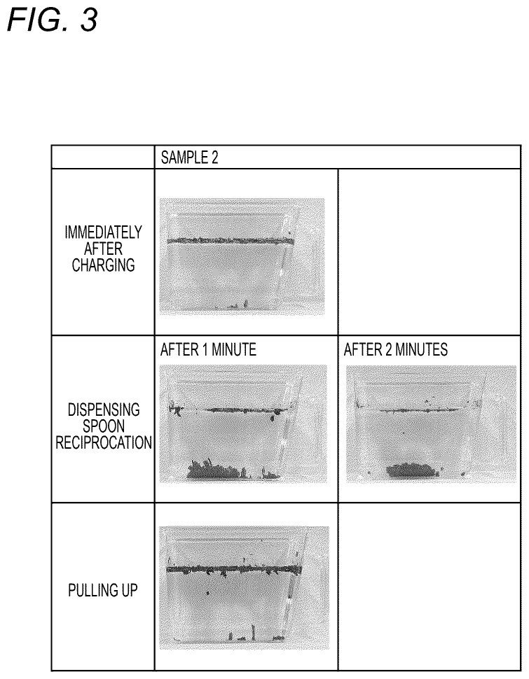

As Experiment 3, as shown in FIG. 3, a behavior when the container was enlarged was verified.

The same sample 2, dispensing spoon, and water as in Experiment 1 were used.

As the container, a plastic container having an opening surface of 130 mm×75 mm and a height of 95 mm was used.

(1) When 500 g of water was charged into the container and 6 g of the sample 2 was gently charged into the container from above, as shown in an upper part in FIG. 3, most of the sample 2 floated on water and about 2% thereof was submerged in water.

(2) Thereafter, when a stirring operation of reciprocating the dispensing spoon in a lateral direction in a state where the dispensing spoon was inserted into water to the middle of the dish portion was performed for 1 minute at 1 reciprocation/second, as shown in left of a middle part in FIG. 3, most of the sample 2 was submerged in water and about 15% thereof remained floating on water. Further, when this stirring operation was additionally performed for 1 minute, as shown in right of the middle part in FIG. 3, a part of the sample 2 was further submerged in water and about 10% thereof remained floating on water.

(3) Thereafter, when the submerged sample 2 was pulled up to above the water surface with a dispensing spoon and then gently charged into water from above again, as shown in a lower part in FIG. 3, most of the sample 2 floated on water again and about 3% thereof remained submerged in the water.

As seen from this result, even when the container (opening area) is larger than that in Experiment 1, the same phenomenon as in Experiment 1 is observed. However, since it tends to take more time than in Experiment 1 when the sample 2 is submerged in water, it is preferable to study the stirring method. For example, a gear may be used to stir the water surface portion, or a rotating body may be provided at the water bottom portion to stir strongly.

### [Experiment 4]

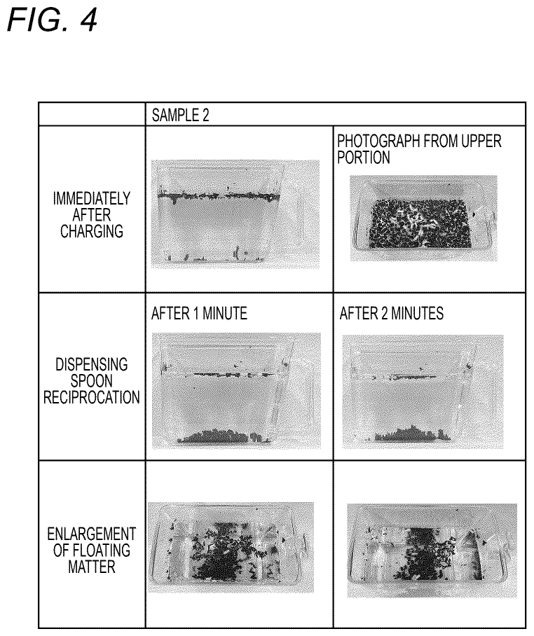

As Experiment 4, as shown in FIG. 4, an experiment of separating a wood piece, as a low specific gravity foreign matter, from the rubber pulverized was performed.

The same sample 2, dispensing spoon, and water as in Experiment 1, and the same container as in Experiment 3 were used.

As the wood piece, a piece obtained by cutting a staple into a length of 5 mm was used.

(1) When 500 g of water was charged into the container and 6 g of the sample 2 was gently charged into the container from above, as shown left and right of an upper part in FIG. 4, most of the pulverized rubber (sample 2) floated on water and about 3% thereof was submerged in water. Further, when 30 wood pieces (0.4 g) were gently charged into the container from above, all of the wood pieces floated.

(2) Thereafter, when a stirring operation of reciprocating the dispensing spoon in a lateral direction in a state where the dispensing spoon was inserted into water to the middle of the dish portion was performed for 1 minute at 1 reciprocation/second, as shown left of a middle part and left of a lower part in FIG. 4, all of the wood pieces remained floating, and most of the sample 2 was submerged in water and about 10% thereof remained floating on water. Further, when this stirring operation was additionally performed for 1 minute, as shown in right of the middle part and right of the lower part in FIG. 4, all of the wood pieces remained floating, and a part of the sample 2 was further submerged in water and about 8% thereof remained floating on water. When the wood pieces and the sample 2 remained floating were taken out and dried to measure the weight, the weight of the wood pieces was 0.4 g and the weight of the sample 2 was 0.5 g.

As seen from this result, an object having a small specific gravity (0.2 to 0.7 in most cases), such as a wood piece, floats on water even when it is stirred as in the stage (2) and is separated from the pulverized rubber submerged in water, so that the floating wood piece can be easily removed. However, depending on the site of the rubber product that has been collected from the market, there is a possibility that the pulverized rubber contains strongly floating particles, and therefore attention needs to be paid to the yield.

### [Experiment 5]

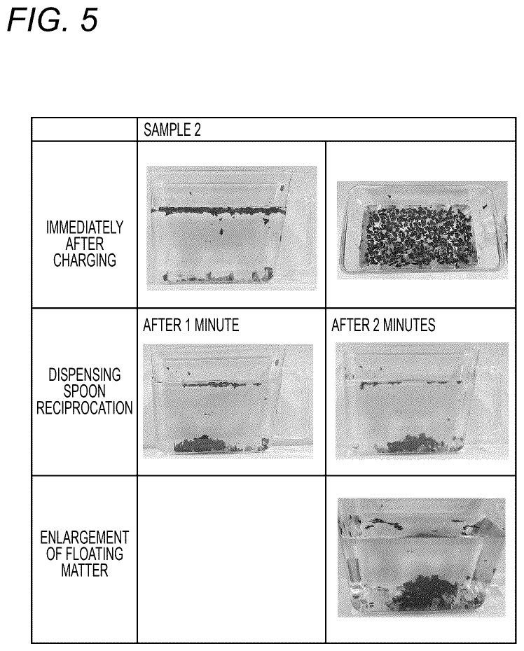

As Experiment 5, as shown in FIG. 5, an experiment of separating a stone, as a high specific gravity foreign matter, from the rubber pulverized was performed.

The same sample 2, dispensing spoon, and water as in Experiment 1, and the same container as in Experiment 3 were used.

As the stone, a stone having a diameter of about 5 mm was used from among boiled rice stones manufactured by Daiso Industries Co., Ltd.

(1) When 500 g of water was charged into the container and 6 g of the sample 2 was gently charged into the container from above, as shown left and right of an upper part in FIG. 5, most of the pulverized rubber (sample 2) floated on water and about 3% thereof was submerged in water. Further, when 30 stones (5.8 g) were gently charged into the container from above, all of the stones were submerged.

(2) Thereafter, when a stirring operation of reciprocating the dispensing spoon in a lateral direction in a state where the dispensing spoon was inserted into water to the middle of the dish portion was performed for 1 minute at 1 reciprocation/second, as shown left of a middle part in FIG. 5, all of the stones remained submerged, and most of the sample 2 was submerged in water and about 4% thereof remained floating on water. Further, when this stirring operation was additionally performed for 1 minute, as shown in right of the middle part and right of a lower part in FIG. 5, all of the stones remained submerged, and a part of the sample 2 was further submerged in water and about 3% thereof remained floating on water.

As seen from this result, most of objects having a large specific gravity (1.5 to 3 in most cases), such as a stone, are submerged in water and are separated from the pulverized rubber floating on water at the stage (1), so that the submerged stone can be easily removed. However, since the separation is difficult when the pulverized rubber is submerged in the stage (2), it is considered that a system for submerging the stone first and then floating the wood piece is preferred.

### First Embodiment

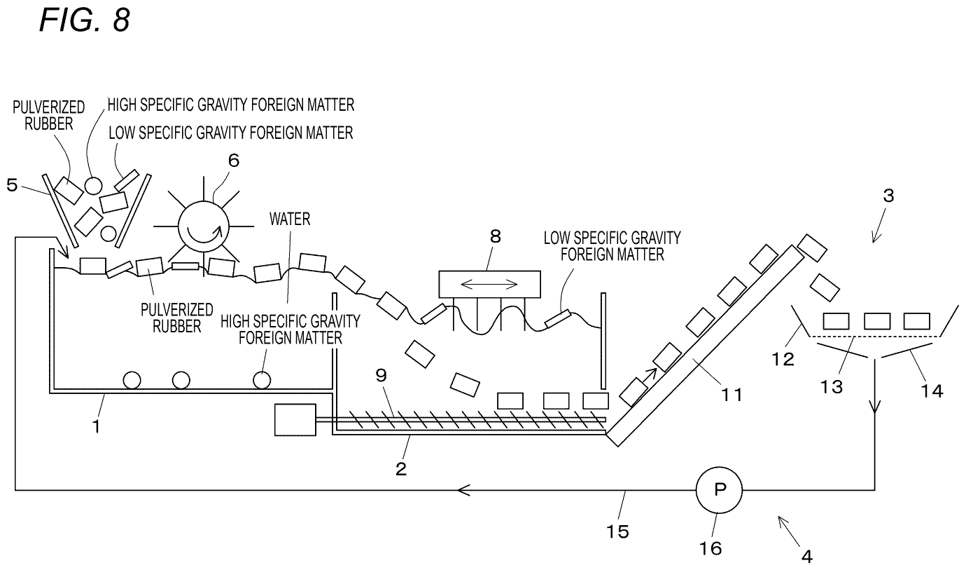

A first embodiment based on the above experiments will be described with reference to FIG. 8. Note that, a configuration of each part in the embodiments is an example, and can be appropriately changed without departing from the gist of the invention.

An apparatus for separating a foreign matter from a pulverized rubber according to the present embodiment includes a first water tank 1 that stores water, a second water tank 2 that is provided adjacent to the first water tank 1 and that stores water overflowing from the first water tank 1, a recovery device 3 that recovers the pulverized rubber fed from the second water tank 2 together with water, and a water circulation device 4 that circulates the water flowing out from the recovery device 3 to the first water tank 1.

The first water tank 1 is provided with a hopper 5 for supplying the pulverized rubber onto water, a water moving device 6 for moving a water surface portion of water toward the second water tank 2 to send the pulverized rubber floating on water to the second water tank 2 together with the overflowing water, and a first removing device (not shown) for removing a high specific gravity foreign matter having a specific gravity of more than 1 submerged in water.

The second water tank 2 is provided with a water stirring device 8 for generating waves in the water surface portion, covering the pulverized rubber floating on water with the waves, and submerging the pulverized rubber in water, an underwater screw 9 for feeding the pulverized rubber submerged in the water together with water from a bottom portion of the second water tank 2, and a second removing device (not shown) for removing a low specific gravity foreign matter having a specific gravity of less than 1 floating on the water.

The recovery device 3 includes a conveyor 11 that obliquely conveys the pulverized rubber fed together with water by the underwater screw 9, and a recovery container 12 that receives the pulverized rubber conveyed by the conveyor 11 together with water. The recovery container 12 includes a bottom plate 13 on which the pulverized rubber is accumulated and through which water passes and drops, and a water collecting plate 14 that collects water dropped from the bottom plate 13.

The water circulation device 4 includes a circulation pipe 15 for circulating water collected by the water collecting plate 14 to the first water tank 1, and a pump 16.

The apparatus configured as described above is used to separate a foreign matter from the pulverized rubber in the following manner. (1) High Specific Gravity Foreign Matter Separation Step

A pulverized rubber in which a high specific gravity foreign matter and a low specific gravity foreign matter are mixed is dropped and supplied from the hopper 5 onto water in the first water tank 1. At this time, since the water surface portion of the water is moved toward the second water tank 2 by the water moving device 6, the pulverized rubber is dispersed and scattered on the moving water (without being narrowed). In this manner, the pulverized rubber is floated on the water by the surface tension of the water acting upward, and the pulverized rubber floated on the water is sent to the second water tank 2 together with the overflowing water by the water moving device 6. Then, the high specific gravity foreign matter submerged in the water in the first water tank 1 and separated is removed by the first removing device.

### (2) Low Specific Gravity Foreign Matter Separation Step

Waves are generated in the water surface portion of the water in the second water tank 2 by the water stirring device 8. Therefore, the pulverized rubber fed from the first water tank 1 to the second water tank 2 is covered with water by the waves in the water surface portion. In this manner, the surface tension of the water acting upward is eliminated to submerge the pulverized rubber in the water, and the pulverized rubber submerged in the water is fed from the second water tank 2 together with the water flowing out from the bottom portion by the underwater screw 9. Then, the low specific gravity foreign matter floating on the water in the second water tank 2 and separated is removed by the second removing device.

### (3) Recovery of Pulverized Rubber and Circulation of Water

The pulverized rubber fed together with the water by the underwater screw 9 is conveyed by the conveyor 11 of the recovery device 3 and received by the recovery container 12. The water collected by collecting the pulverized rubber accumulated on the bottom plate 13 and dropping into the water collecting plate 14 is circulated to the first water tank 1 by the water circulation device 4.

According to the present embodiment, it is possible to separate various foreign matters such as a metal, a stone, sand, mud, wood, and a plastic from a pulverized rubber by using a simple facility. Further, since the above steps are performed simultaneously and continuously, the efficiency is high.

### Second Embodiment

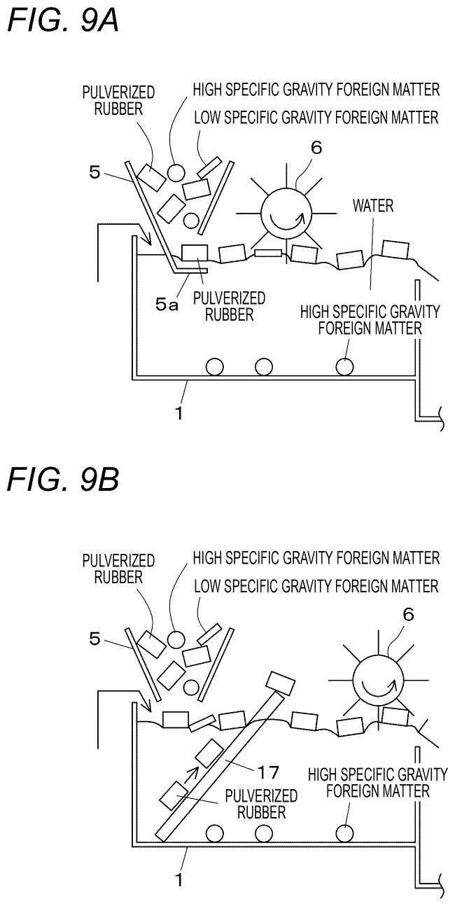

A second embodiment shown in FIG. 9A is different from the first embodiment in that the hopper 5 is provided with a submerging prevention portion 5a that receives the pulverized rubber immediately below the water surface and that prevents the pulverized rubber from submerging in the water due to a force of falling from the hopper 5. Other respects are the same as in the first embodiment.

According to the present embodiment, in addition to the same effect as that of the first embodiment, a recovery rate of the pulverized rubber can be increased.

### Third Embodiment

A third embodiment shown in FIG. 9B is different from the first embodiment in that a re-charging device 17 is provided in the first water tank 1 to bring the pulverized rubber that has been submerged in water back onto the water and re-charge the pulverized rubber into the water considering that some of the pulverized rubber may be submerged into the water due to the force of falling from the hopper 5. Other respects are the same as in the first embodiment.

According to the present embodiment, in addition to the same effect as that of the first embodiment, a recovery rate of the pulverized rubber can be increased.

### Fourth Embodiment

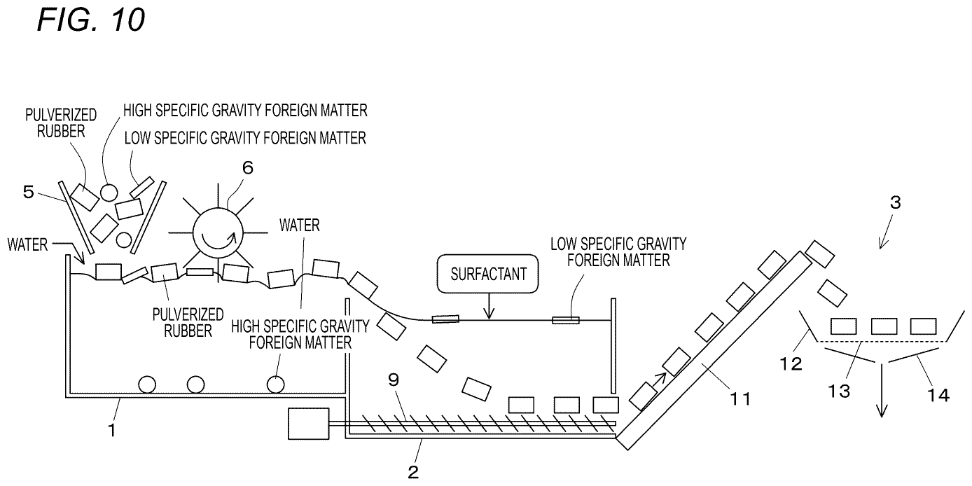

A fourth embodiment shown in FIG. 10 is different from the first embodiment in that 0.2% or more of the surfactant is added to the water in the second water tank 2, the surface of the pulverized rubber is made hydrophilic, and the upward surface tension is eliminated, so that the pulverized rubber is reliably submerged in the water, and that when the water containing the surfactant is circulated in the first water tank 1, the pulverized rubber is not floated on the water in the first water tank 1, so that the circulation is not performed. Other respects are the same as in the first embodiment. Note that, the stirring of water by the water stirring device 8 in the first embodiment may be used in combination.

According to the present embodiment, in addition to the same effect as that of the first embodiment, a recovery rate of the pulverized rubber can be increased.

Note that, the present invention is not limited to the aforementioned embodiments and can be appropriately modified and carried out within a scope that does not deviate from the spirit of the invention.

### REFERENCE SIGNS LIST

1 first water tank
2 second water tank
3 recovery device
4 water circulation device
5 hopper
5a submerging prevention portion
6 water moving device
8 water stirring device
9 underwater screw
11 conveyor
12 recovery container
13 bottom plate
14 water collecting plate
15 circulation pipe
16 pump
17 re-charging device

What is claimed is:

1. A method for separating, from a pulverized rubber having a specific gravity of more than 1, a foreign matter mixed in the pulverized rubber, the method comprising:
separating a high specific gravity foreign matter having a specific gravity of more than 1, which is submerged in water, by floating the pulverized rubber on the water by a surface tension of the water acting upward; and
separating a low specific gravity foreign matter having a specific gravity of less than 1, which floats on the water, by submerging the pulverized rubber in the water by a process of eliminating or reducing the surface tension of the water acting upward.

2. The method according to claim 1, wherein the process of eliminating or reducing the surface tension of the water acting upward is covering the pulverized rubber with water.

3. The method according to claim 1, wherein the process of eliminating or reducing the surface tension of the water acting upward is adding a surfactant to the water.

4. The method according to claim 1, wherein the process of eliminating or reducing the surface tension of the water acting upward is adding an alcohol to the water.

5. The method according to claim 1, wherein the process of eliminating or reducing the surface tension of the water acting upward is increasing a temperature of the water.

6. The method according to claim 1, wherein the process of eliminating or reducing the surface tension of the water acting upward is applying ultrasonic vibration to the water.

7. The method according to claim 1, wherein the separating of the low specific gravity foreign matter is performed after the separating of the high specific gravity foreign matter.

8. The method according to claim 2, wherein the separating of the low specific gravity foreign matter is performed after the separating of the high specific gravity foreign matter.

9. The method according to claim 3, wherein the separating of the low specific gravity foreign matter is performed after the separating of the high specific gravity foreign matter.

10. The method according to claim 4, wherein the separating of the low specific gravity foreign matter is performed after the separating of the high specific gravity foreign matter.

11. The method according to claim 5, wherein the separating of the low specific gravity foreign matter is performed after the separating of the high specific gravity foreign matter.

12. The method according to claim 6, wherein the separating of the low specific gravity foreign matter is performed after the separating of the high specific gravity foreign matter.

13. An apparatus for separating a foreign matter from a pulverized rubber, comprising:
a first water tank configured to float the pulverized rubber on water by a surface tension of the water acting upward to separate a high specific gravity foreign matter having a specific gravity of more than 1, which is submerged in the water; and
a second water tank configured to submerge the pulverized rubber in water by eliminating or reducing the surface tension of the water acting upward to separate a low specific gravity foreign matter having a specific gravity of less than 1, which floats on the water, wherein
the pulverized rubber floating on the water in the first water tank is sent to the second water tank together with water overflowing from the first water tank.

14. The apparatus for separating a foreign matter from a pulverized rubber according to claim 13, wherein the first water tank is provided with: a hopper configured to supply the pulverized rubber onto the water; and a first removing device configured to remove the high specific gravity foreign matter submerged in the water.

15. The apparatus for separating a foreign matter from a pulverized rubber according to claim 13, wherein the second water tank is provided with: a water stirring device configured to generate waves on a surface of the water, to cover, with the waves, the pulverized rubber floating on the water, so as to submerge the pulverized rubber in the water; and a second removing device configured to remove the low specific gravity foreign matter floating on the water.

16. The apparatus for separating a foreign matter from a pulverized rubber according to claim 13, wherein a surfactant is added to the water in the second water tank.

17. The apparatus for separating a foreign matter from a pulverized rubber according to claim 13, further comprising:
a recovery device configured to recover the pulverized rubber taken out from the second water tank.

18. The apparatus for separating a foreign matter from a pulverized rubber according to claim 14, further comprising:
a recovery device configured to recover the pulverized rubber taken out from the second water tank.

19. The apparatus for separating a foreign matter from a pulverized rubber according to claim 15, further comprising:
a recovery device configured to recover the pulverized rubber taken out from the second water tank.

20. The apparatus for separating a foreign matter from a pulverized rubber according to claim 16, further comprising:
a recovery device configured to recover the pulverized rubber taken out from the second water tank.
